(19) United States
(12) Patent Application Publication
(10) Pub. No.: US 2019/0130823 A1
(43) Pub. Date: May 2, 2019

(54) PIXEL CIRCUIT

(71) Applicant: Chunghwa Picture Tubes, LTD., Taoyuan City (TW)

(72) Inventors: Shang-Jung Yang, Taichung City (TW); Chi-Chung Tsai, Taoyuan City (TW); Chin-Hai Huang, Taoyuan City (TW); En-Chih Liu, Taoyuan City (TW); Yen-Yu Huang, Taoyuan City (TW)

(73) Assignee: Chunghwa Picture Tubes, LTD., Taoyuan City (TW)

(21) Appl. No.: 15/867,729

(22) Filed: Jan. 11, 2018

(30) Foreign Application Priority Data
Nov. 2, 2017 (CN) 201711061568.4

(51) Int. Cl. G09G 3/3225

(52) U.S. Cl. CPC G09G 3/3225; G09G 2300/0819; G09G 2320/0233; G09G 2320/045

(57) ABSTRACT

The disclosure provides a pixel circuit for driving a light emitting diode. A second terminal of a driving transistor is coupled to a first terminal of the light emitting diode, and a control terminal of the driving transistor receives a bias voltage. A coupling switch is coupled between a first terminal and the control terminal of the driving transistor and controlled by a first selection signal to be turned on or off. A first terminal of a first switch receives a display data voltage or a reference voltage, and the first switch is controlled by a second selection signal to be turned on or off. A first terminal of a second switch is coupled to a second terminal of the first switch. A second terminal of the second switch is coupled between the second terminal of the driving transistor and the light emitting diode, and the second switch is controlled by the first selection signal to be turned on or off. A first terminal of a capacitor is coupled between the second terminal of the first switch and the first terminal of the second switch, and a second terminal of the capacitor supplies the bias voltage to the control terminal of the driving transistor. An emitting switch is coupled between an operating power supply and the first terminal of the driving transistor and controlled by an emitting control signal to be turned on or off.

### CROSS-REFERENCE TO RELATED APPLICATION

This application claims the priority benefit of China application serial no. 201711061568.4, filed on Nov. 2, 2017. The entirety of the above-mentioned patent application is hereby incorporated by reference herein and made a part of this specification.

### BACKGROUND

### Technical Field

The disclosure relates to a pixel circuit, and more particularly to a pixel circuit for driving a light emitting diode.

### Description of Related Art

In recent years, light-emitting diodes have been widely used in flat panel displays. Among them, organic light-emitting diodes (OLEDs) which owns advantages such as high contrast ratio, low power consumption, light weight and flexibility because of the self-luminous characteristic are particularly regarded as a very promising display technology.

In the existing active-matrix organic light-emitting diode (AMOLED) panel, the light-emitting diode is often illuminated by operating the current generated in the saturation region via a driving transistor. However, the transistor-driving mode is easily affected by the process (manufacturing process). Therefore, if the threshold voltage of the driving transistor is changed due to the difference in the process or the operation for a long time, the characteristics of the transistor are changed to cause the phenomenon of the nonuniform brightness of the AMOLED.

### SUMMARY

In view of the above, the disclosure provides a pixel circuit in which the driving current for driving the light-emitting diode is irrelevant to the threshold voltage of the driving transistor, and thus the impact resulted from the variation of the threshold voltage of the driving transistor due to various factors and the impact of the process can be overcome. In addition, the problem of the nonuniform brightness of the display can also be overcome by providing the light-emitting diode with a stable brightness.

According to an embodiment of the disclosure, there is provided a pixel circuit for driving a light emitting diode, including a driving transistor, a coupling switch, a first switch, a second switch, a capacitor, and an emitting switch. The driving transistor has a first terminal, a second terminal, and a control terminal, wherein the second terminal of the driving transistor is coupled to a first terminal of the light emitting diode, and the control terminal of the driving transistor receives a bias voltage. The coupling switch is coupled between the first terminal and the control terminal of the driving transistor, and the coupling switch is controlled by a first selection signal to be turned on or off. A first terminal of the first switch receives a display data voltage or a reference voltage, and the first switch is controlled by a second selection signal to be turned on or off. A first terminal of the second switch is coupled to a second terminal of the first switch. A second terminal of the second switch is coupled between the second terminal of the driving transistor and the light emitting diode, and the second switch is controlled by the first selection signal to be turned on or off. A first terminal of the capacitor is coupled between the second terminal of the first switch and the first terminal of the second switch, and the second terminal of the capacitor supplies the bias voltage to the control terminal of the driving transistor. The emitting switch is coupled between an operating power supply and the first terminal of the driving transistor and controlled by an emitting control signal to be turned on or off.

In the pixel circuit according to an embodiment of the disclosure, a second terminal of the light emitting diode receives a reference ground voltage, and the voltage value of the reference voltage is not greater than the sum of the voltage values of the reference ground voltage and a threshold voltage of the light emitting diode.

In the pixel circuit according to an embodiment of the disclosure, the first switch, the second switch, the coupling switch and the emitting switch are turned on and the first terminal of the first switch receives the reference voltage during an initial time period; the first switch, the second switch and the coupling switch are turned on and the emitting switch is turned off, and the first terminal of the first switch receives the reference voltage during a compensation time period; the first switch is turned on and the emitting switch, the second switch, and the coupling switch are turned off, and the first terminal of the first switch receives the display data voltage during a data writing time period; and the emitting switch is turned on, the first switch, the second switch, and the coupling switch are turned off, and the first terminal of the first switch receives the reference voltage during an emitting time period.

In the pixel circuit according to an embodiment of the disclosure, the initial time period is before the compensation time period, the compensation time period is before the data writing time period, and the data writing time period is before the emitting time period.

In the pixel circuit according to an embodiment of the disclosure, the capacitor is charged so that the bias voltage is substantially equal to the voltage of the operating power supply during the initial time period, and the capacitor is discharged so that the bias voltage is substantially equal to Vth+Vref during the compensation time period, wherein Vth is the threshold voltage of the driving transistor and Vref is the reference voltage.

In the pixel circuit according to an embodiment of the disclosure, the bias voltage is substantially equal to Vdata−Vref+Vth during the data writing time period and the emitting time period, wherein Vdata is the display data voltage, Vref is the reference voltage, and Vth is the threshold voltage of the driving transistor, and the driving transistor drives the light emitting diode according to the bias voltage during the emitting time period.

In the pixel circuit according to an embodiment of the disclosure, the driving transistor supplies a driving current to the light emitting diode during the emitting time period, wherein the driving current is substantially equal to K(Vdata−Vref−VSS−Voled)², wherein VSS is the reference ground voltage, Voled is the threshold voltage of the light emitting diode, and K is a constant.

In the pixel circuit according to an embodiment of the disclosure, when the driving transistor is an N-channel transistor, the coupling switch, the first switch, the second switch, and the emitting switch are N-channel transistors, and the voltage value of the display data voltage is not greater than the voltage value of the operating power supply, and the voltage value of the display data voltage is greater than the voltage value of the reference voltage.

In the pixel circuit according to an embodiment of the disclosure, when the driving transistor is a P-channel transistor, the coupling switch, the first switch, the second switch, and the emitting switch are P-channel transistors, and the voltage value of the reference voltage is not greater than the voltage value of the operating power supply, and the voltage value of the reference voltage is greater than the voltage value of the display data voltage.

In the pixel circuit according to an embodiment of the disclosure, the on or off state of the coupling switch is the same as the on or off state of the second switch.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 shows a schematic diagram of a pixel circuit according to an embodiment of the disclosure.

FIG. 2 shows a schematic diagram of a pixel circuit according to another embodiment of the disclosure.

FIG. 3 shows an operation waveform diagram of a pixel circuit according to an embodiment of the disclosure.

FIG. 4 shows a schematic diagram of a pixel circuit according to another embodiment of the disclosure.

FIG. 5 shows an operation waveform diagram of a pixel circuit according to another embodiment of the disclosure.

### DESCRIPTION OF THE EMBODIMENTS

Reference will now be made in detail to the exemplary embodiments of the disclosure, examples of which are illustrated in the accompanying drawings. Wherever possible, the same reference numbers will be used throughout the drawings and the description to refer to the same or like parts.

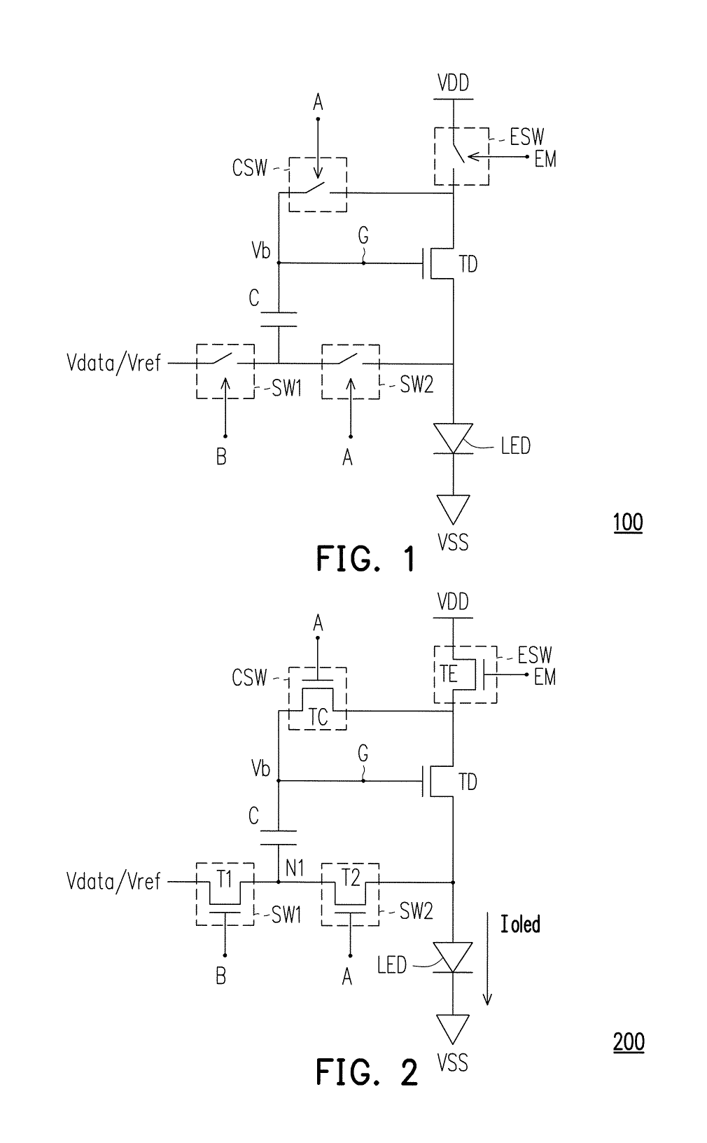

Referring to FIG. 1, FIG. 1 shows a schematic diagram of a pixel circuit according to an embodiment of the disclosure. The pixel circuit 100 may be used to drive a light emitting diode LED, wherein the light emitting diode LED may be an organic or inorganic light emitting diode. The pixel circuit 100 includes a driving transistor TD, a coupling switch CSW, a capacitor C, an emitting switch ESW, a first switch SW1, and a second switch SW2. The driving transistor TD has a first terminal, a second terminal, and a control terminal G, wherein the second terminal of the driving transistor TD is coupled to a first terminal (e.g, an anode terminal) of the light emitting diode LED, and the control terminal G of the driving transistor TD receives a bias voltage Vb. The coupling switch CSW is coupled between the control terminal G and the first terminal of the driving transistor TD and the coupling switch CSW is turned on or off according to a first selection signal A. A first terminal of the first switch SW1 receives a display data voltage Vdata or a reference voltage Vref, and the first switch SW1 is controlled by a second selection signal B to be turned on or off. A first terminal of the second switch SW2 is coupled to a second terminal of the first switch SW1. A second terminal of the second switch SW2 is coupled between the second terminal of the driving transistor TD and the light emitting diode LED, and the second switch SW2 is controlled by the first selection signal A to be turned on or off. A first terminal of the capacitor C is coupled between the second terminal of the first switch SW1 and the first terminal of the second switch SW2, and a second terminal of the capacitor C supplies the bias voltage Vb to the control terminal G of the driving transistor TD. The emitting switch ESW is coupled between an operating power supply VDD and the first terminal of the driving transistor TD and controlled by an emitting control signal EM to be turned on or off. In addition, a second terminal (e.g., a cathode terminal) of the light emitting diode LED is coupled to the reference ground voltage VSS.

It should be noted that in this embodiment, the voltage level of the operating power supply VDD is greater than the voltage levels of the display data voltage Vdata and the reference voltage Vref. The voltage value of the reference voltage Vref is not greater than the sum of the voltage values of reference ground voltage VSS and the threshold voltage of the light emitting diode LED. In addition, the on or off state of the second switch SW2 is the same as the on or off state of the coupling switch CSW.

Referring to FIG. 2, FIG. 2 shows a schematic diagram of a pixel circuit according to another embodiment of the disclosure. The pixel circuit 200 includes a driving transistor TD, a capacitor C, a coupling switch CSW, an emitting switch ESW, a first switch SW1, and a second switch SW2. The coupling switch CSW, the emitting switch ESW, the first switch SW1, and the second switch SW2 are transistor switches constructed respectively by transistors TC, TE, T1, and T2. In this embodiment, the driving transistor TD is an N-channel transistor, and the transistors TC, TE, T1, and T2 are all also N-channel transistors.

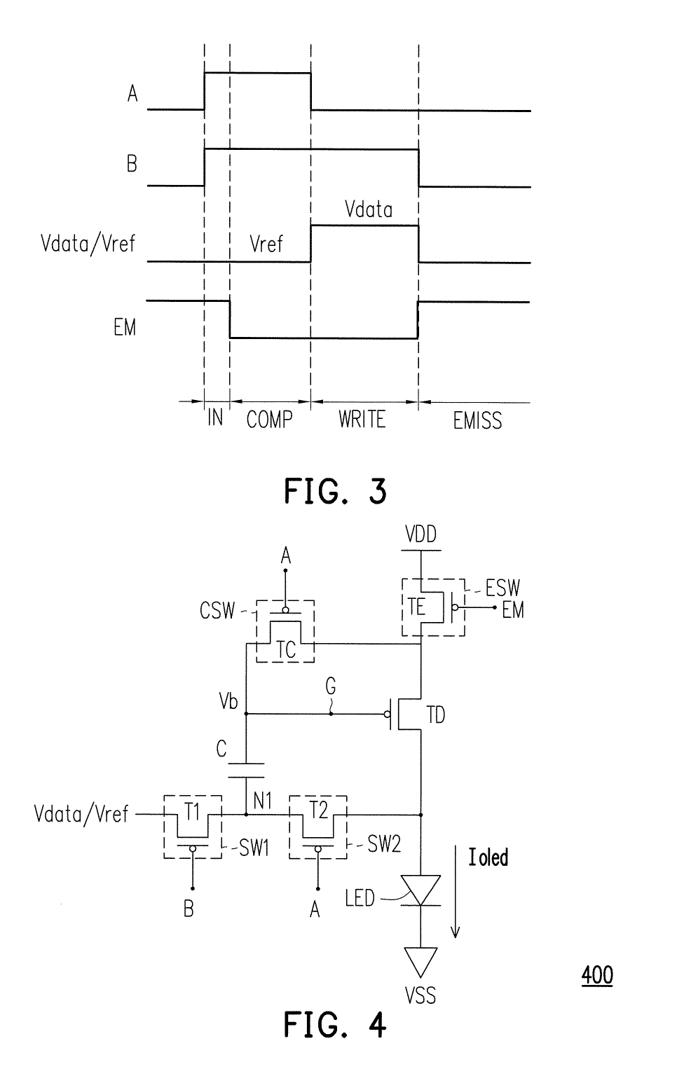

Referring to both of FIG. 3 and FIG. 2 for the circuit operation, FIG. 3 shows an operation waveform diagram of a pixel circuit according to an embodiment of the disclosure. During the initial time period IN, the emitting control signal EM, the first selection signal A, and the second selection signal B are high-level signals (for example, logic high level), while the first terminal of the first switch SW1 receives the reference voltage Vref. In this embodiment, the voltage value of the display data voltage Vdata is not greater than the voltage value of the operating power supply VDD, and the voltage value of the display data voltage Vdata is greater than the voltage value of the reference voltage Vref. That is, compared to the display data voltage Vdata, the reference voltage Vref is a low level signal (for example, logic low level). The emitting switch ESW is turned on according to the emitting control signal EM. In addition, the first switch SW1 is turned on according to the second selection signal B, and the coupling switch CSW and the second switch SW2 are turned on according to the first selection signal A. At this moment, the capacitor C is charged by the turned-on emitting switch ESW and the turned-on coupling switch CSW so that the bias voltage Vb is substantially equal to the voltage of the operating power supply VDD. That is, the bias voltage Vb received at the control terminal G of the driving transistor TD is substantially equal to the voltage of the operating power supply VDD.

In addition, the reference voltage Vref is transmitted to the first terminal of the capacitor C through the first switch SW1, and the reference voltage Vref is also transmitted to the first terminal (the anode terminal in this embodiment) of the light emitting diode LED through the second switch SW2. Since the voltage value of the reference voltage Vref is not greater than the sum of the voltage values of the reference ground voltage VSS and the threshold voltage of the light emitting diode LED, that is, the cross voltage between the anode terminal and the cathode terminal of the light emitting diode LED is smaller than the driving voltage of the light emitting diode LED, the light emitting diode LED does not emit light and does not emit light due to the emitting control signal EM which is a high level signal. Therefore, the pixel circuit 200 of this embodiment can prevent the light emitting diode LED from flickering during the initial time period IN.

Then, during the compensation time period COMP, the emitting control signal EM is changed to a low level signal, and the first selection signal A and the second selection signal B are maintained as high level signals. Correspondingly, the emitting switch ESW is turned off, and the first switch SW1, the second switch SW2 and the coupling switch CSW are remained turned on. The first terminal of the first switch SW1 still keeps receiving the reference voltage Vref. Because of the coupling switch CSW and the second switch SW2 that are in the on-state and the emitting switch ESW that is in the off-state, the driving transistor TD and the capacitor C form a diode-connection.

At this moment, the capacitor C starts to be discharged. The capacitor C is discharged until the potential stored by the capacitor C is substantially equal to the threshold voltage of the driving transistor TD. Therefore, the voltage value of the bias voltage Vb is substantially equal to Vth+Vref, wherein Vth is the threshold voltage of the driving transistor TD.

It should be noted that during the discharging of the capacitor C, the anode terminal of the light emitting diode LED receives the reference voltage Vref so that the cross voltage between the anode terminal and the cathode terminal of the light emitting diode LED is less than the driving voltage of the light emitting diode LED. Therefore, the light emitting diode LED at this stage will still not be driven to emit light or flicker.

Next, during the data writing time period WRITE, the emitting control signal EM is maintained as a low level signal, the first selection signal A is changed to a low level signal, and the second selection signal B is maintained as the high level signal. The first terminal of the first switch SW1 is changed to receive the display data voltage Vdata, so the first switch SW1 may control the writing of the display data. Accordingly, the first switch SW1 maintains the on state, and the emitting switch ESW, the second switch SW2 and the coupling switch CSW are turned off. Through the first switch SW1, the display data voltage Vdata is transmitted to the node N1 between the capacitor C and the first switch SW1 so that the capacitor C can store the display data voltage Vdata, and because of the turned-off second switch SW2 and the capacity coupling effect, the bias voltage Vb at this moment is substantially equal to Vdata−Vref+Vth.

In the emitting time period EMISS, the emitting control signal EM is changed to a high level signal to turn on the emitting switch ESW, the first selection signal A is maintained as the low level signal, the second selection signal B is changed to a low level signal so that the first switch SW1, the second switch SW2 and the coupling switch CSW are all turned off. At this stage, the first terminal of the first switch SW1 is changed to receive the reference voltage Vref. The first terminal of the driving transistor TD receives the operation power supply VDD through the turned-on emitting switch ESW. The driving transistor TD may provide the driving current Ioled to drive the light emitting diode LED according to the bias voltage Vb received by the control terminal G, and at this moment, the bias voltage Vb is substantially equal to Vdata−Vref+Vth (the bias voltage Vb is maintained at the voltage level obtained in the data writing time period WRITE).

It should be noted that, since the emitting switch ESW is turned off during the data writing time period WRITE, the light emitting diode LED will not be driven to emit light until the emitting time period EMISS. Therefore, during the emitting time period EMISS, the bias voltage Vb received by the control terminal G of the driving transistor TD may be substantially maintained at Vdata−Vref+Vth.

Since the second switch SW2 is turned off, the voltage level of the anode terminal of the light emitting diode LED is VSS+Voled, wherein Voled is the threshold voltage of the light emitting diode LED. The equation for calculating the driving current Ioled can be seen in equation (1):

$$Ioled = {K ( {V}_{GS} - Vth )}^{2} = {K [ ( Vdata - Vref + Vth ) - ( VSS + Voled ) - Vth ]}^{2} = {K ( Vdata - Vref - VSS - Voled )}^{2} \qquad ( 1 )$$

wherein V_{GS} in equation (1) is the voltage difference between the control terminal G and the second terminal (source terminal) of the driving transistor TD, and K is a constant. From equation (1), in this embodiment, the driving current Ioled generated by the driving transistor TD is only related to the reference voltage Vref, the display data voltage Vdata, the threshold voltage Voled of the light emitting diode and the reference ground voltage VSS, and is not affected by the threshold voltage Vth of the driving transistor TD.

In this embodiment, the driving current Ioled generated by the pixel circuit 200 may not be affected by the variation of the threshold voltage Vth of the driving transistor TD. Therefore, the light emitting diode LED can be driven to generate a light source with a stable brightness and the problem of the nonuniform brightness of the panel can be solved.

Referring to FIG. 4, FIG. 4 shows a schematic diagram of a pixel circuit according to another embodiment of the disclosure. The pixel circuit 400 includes a driving transistor TD, a capacitor C, a coupling switch CSW, an emitting switch ESW, a first switch SW1, and a second switch SW2. The coupling switch CSW, the emitting switch ESW, the first switch SW1, and the second switch SW2 are transistor switches constructed respectively by transistors TC, TE, T1, and T2. Different from the previous embodiments, the driving transistor TD of the pixel circuit 400 is a P-channel transistor, and the transistors TC, TE, T1, and T2 are all P-channel transistors. The detailed configuration relationship can be implemented from the pixel circuit 200 in FIG. 2, and thus will not be repeated here.

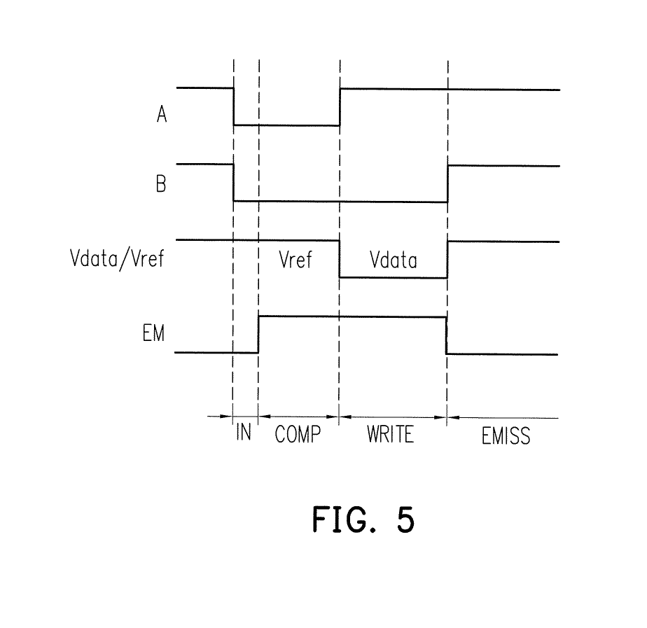

Referring to both of FIG. 5 and FIG. 4 for the circuit operation, FIG. 5 shows an operation waveform diagram of a pixel circuit according to another embodiment of the disclosure. Since the voltage polarity and the current direction of the P-channel transistor and the N-channel transistor are opposite, the operation waveform diagram of FIG. 5 and the voltage level operation in FIG. 4 are reverse. One of ordinary skill in the art based on common general knowledge and the implementation of the above embodiments should be able to obtain enough teaching, suggestions and implementation instructions, and therefore detailed description is not repeated.

In this embodiment, the voltage value of the reference voltage Vref is not greater than the voltage value of the operating power supply VDD, and the voltage value of the reference voltage Vref is still less than the sum of the voltage values of the reference ground voltage VSS and the threshold voltage of the light emitting diode. In addition, the voltage value of the reference voltage Vref is greater than the voltage value of the display data voltage Vdata. That is, compared to the display data voltage Vdata, the reference voltage Vref is a high level signal.

During the initial time period, the emitting control signal EM, the first selection signal A, the second selection signal B are low level signal and correspondingly the emitting switch ESW, the coupling switch CSW, the first switch SW1 and the second switch SW2 are all turned on. Therefore, the capacitor C is charged so that the bias voltage Vb is substantially equal to the voltage level of the operating power supply VDD by the turned-on emitting switch ESW and the turned-on coupling switch CSW. In addition, the first terminal of the first switch SW1 receives the reference voltage Vref at this moment, and the reference voltage Vref is transmitted to the anode terminal of the light emitting diode LED through the first switch SW1 and the second switch SW2. Since the voltage value of the reference voltage Vref is not greater than the sum of the voltage values of the reference ground voltage VSS and the threshold voltage of the light emitting diode LED, the light emitting diode LED does not emit light or flick at this moment.

Then, during the compensation time period COMP, the emitting control signal EM is changed to a high level signal, and the first selection signal A and the second selection signal B are maintained as low level signals. Correspondingly, the emitting switch ESW is turned off, and the first switch SW1, the second switch SW2 and the coupling switch CSW remain turned on. The first terminal of the first switch SW1 still keeps receiving the reference voltage Vref. At this moment, the capacitor C starts to be discharge. The capacitor C is discharged until the potential stored by the capacitor C is substantially equal to the threshold voltage of the driving transistor TD.

The anode terminal of the light emitting diode LED receives the reference voltage Vref during the discharging of the capacitor C. Therefore, the light emitting diode LED will still not be driven to emit light or flicker at this stage.

Next, during the data writing time period WRITE, the emitting control signal EM is maintained as the high level signal, the first selection signal A is changed to a high level signal, and the second selection signal B is maintained as the low level signal. The first terminal of the first switch SW1 is changed to receive the display data voltage Vdata. Accordingly, the first switch SW1 maintains the on state, and the emitting switch ESW, the second switch SW2 and the coupling switch CSW are turned off. Through the first switch SW1, the display data voltage Vdata is transmitted to the node N1 between the capacitor C and the first switch SW1 so that the capacitor C can store the display data voltage Vdata.

During the emitting time period EMISS, the emitting control signal EM is changed to a low level signal to turn on the emitting switch ESW, the first selection signal A is maintained as the high level signal, the second selection signal B is changed to a high level signal so that the first switch SW1, the second switch SW2 and the coupling switch CSW are all turned off. At this stage, the first terminal of the first switch SW1 is changed to receive the reference voltage Vref.

It should be noted that, since the emitting switch ESW is turned off during the data writing time period WRITE, the light emitting diode LED will not be driven to emit light until the emitting time period EMISS. Therefore, in this embodiment, the driving current Ioled generated by the driving transistor TD is still not affected by the variation of the threshold voltage Vth of the driving transistor TD.

In summary, in the pixel circuit of the disclosure, the capacitor is charged during the initial time period so that the bias voltage received by the control terminal of the driving transistor is substantially equal to the voltage value of the operating power supply; the capacitor is discharged during the compensation time period so that the stored potential of the capacitor is substantially equal to the threshold voltage of the driving transistor; during the data writing time period, the display data voltage is stored in the capacitor; and during the emitting time period, the driving transistor generates a driving current according to the bias voltage provided by the capacitor so as to drive the light emitting diode. Therefore, the driving current generated by the driving transistor is not related to the threshold voltage of the driving transistor. That is to say, the pixel circuit of the disclosure can overcome the impact resulted from the variation of the threshold voltage of the driving transistor due to various factors and the impact of the process, and the problem of the nonuniform brightness of the display can also be overcome by providing the light-emitting diode with a stable brightness.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A pixel circuit for driving a light emitting diode, comprising:
a driving transistor having a first terminal, a second terminal, and a control terminal, wherein the second terminal of the driving transistor is coupled to a first terminal of the light emitting diode, and the control terminal of the driving transistor receives a bias voltage;
a coupling switch coupled between the first terminal and the control terminal of the driving transistor and controlled by a first selection signal to be turned on or off;
a first switch, wherein a first terminal of the first switch receives a display data voltage or a reference voltage, and the first switch is controlled by a second selection signal to be turned on or off;
a second switch, wherein a first terminal of the second switch is coupled to a second terminal of the first switch; a second terminal of the second switch is coupled between the second terminal of the driving transistor and the light emitting diode; and the second switch is controlled by the first selection signal to be turned on or off;
a capacitor, wherein a first terminal of the capacitor is coupled between the second terminal of the first switch and the first terminal of the second switch, and a second terminal of the capacitor supplies the bias voltage to the control terminal of the driving transistor; and
an emitting switch coupled between an operating power supply and the first terminal of the driving transistor and controlled by an emitting control signal to be turned on or off.

2. The pixel circuit according to claim 1, wherein a second terminal of the light emitting diode receives a reference ground voltage, and the voltage value of the reference voltage is not greater than the sum of the voltage values of the reference ground voltage and a threshold voltage of the light emitting diode.

3. The pixel circuit according to claim 1, wherein the first switch, the second switch, the coupling switch and the emitting switch are turned on and the first terminal of the first switch receives the reference voltage during an initial time period; the first switch, the second switch and the coupling switch are turned on and the emitting switch is turned off, and the first terminal of the first switch receives the reference voltage during a compensation time period; the first switch is turned on and the emitting switch, the second switch, and the coupling switch are turned off, and the first terminal of the first switch receives the display data voltage during a data writing time period; and the emitting switch is turned on, the first switch, the second switch, and the coupling switch are turned off, and the first terminal of the first switch receives the reference voltage during an emitting time period.

4. The pixel circuit according to claim 3, wherein the initial time period is before the compensation time period, the compensation time period is before the data writing time period, and the data writing time period is before the emitting time period.

5. The pixel circuit according to claim 4, wherein the capacitor is charged so that the bias voltage is substantially equal to the voltage of the operating power supply during the initial time period, and the capacitor is discharged so that the bias voltage is substantially equal to Vth+Vref during the compensation time period, wherein Vth is the threshold voltage of the driving transistor and Vref is the reference voltage.

6. The pixel circuit according to claim 4, wherein the bias voltage is substantially equal to Vdata−Vref+Vth during the data writing time period and the emitting time period, wherein Vdata is the display data voltage and Vref is the reference voltage, and Vth is the threshold voltage of the driving transistor, and the driving transistor drives the light emitting diode according to the bias voltage during the emitting time period.

7. The pixel circuit according to claim 6, wherein the driving transistor supplies a driving current to the light emitting diode during the emitting time period, wherein the driving current is substantially equal to K(Vdata−Vref−VSS−Voled)², wherein VSS is the reference ground voltage, Voled is the threshold voltage of the light emitting diode, and K is a constant.

8. The pixel circuit according to claim 1, wherein when the driving transistor is an N-channelN-channel transistor, the coupling switch, the first switch, the second switch, and the emitting switch are N-channelN-channel transistors, wherein the voltage value of the display data voltage is not greater than the voltage value of the operating power supply, and the voltage value of the display data voltage is greater than the voltage value of the reference voltage.

9. The pixel circuit according to claim 1, wherein when the driving transistor is a P-channel transistor, the coupling switch, the first switch, the second switch, and the emitting switch are P-channel transistors, wherein the voltage value of the reference voltage is not greater than the voltage value of the operating power supply, and the voltage value of the reference voltage is greater than the voltage value of the display data voltage.

10. The pixel circuit according to claim 1, wherein the on or off state of the coupling switch is the same as the on or off state of the second switch.
